(19) United States
(12) Patent Application Publication
(10) Pub. No.: US 2017/0316436 A1
(43) Pub. Date: Nov. 2, 2017

(54) CONTEXT-AWARE CURVE-FITTING FOR PIPELINE VALUE PREDICTION

(71) Applicant: International Business Machines Corporation, Armonk, NY (US)

(72) Inventors: Aly Megahed, San Jose, CA (US); Hamid R. Motahari Nezhad, San Jose, CA (US); Peifeng Yin, San Jose, CA (US)

(21) Appl. No.: 15/142,402

(22) Filed: Apr. 29, 2016

(51) Int. Cl. G06Q 30/02; G06N 7/00; G06N 5/02

(52) U.S. Cl. CPC G06Q 30/0202; G06N 5/02; G06N 7/005

(57) ABSTRACT

A computer-implemented method includes learning one or more historical curves based on historical data that describes two or more historical pipelines of sales contracts. Each of the one or more historical curves is based on a corresponding historical pipeline of the two or more historical pipelines. Two or more similarity indices are generated, where each similarity index corresponds to a historical pipeline of the two or more historical pipelines, and each similarity index is based on similarity between the corresponding historical pipeline and a target pipeline for which a prediction is sought. A first curve is fit, by a computer processor, to the target pipeline, where the target pipeline has unknown data, and the first curve is based on the two or more similarity indices. A pipeline value of the target pipeline is predicted based on the first curve.

### BACKGROUND

Embodiments of the present invention relate to pipeline value prediction and, more specifically, to context-aware curve-fitting for pipeline value prediction.

A vendor's pipeline generally includes various sales contracts, each at a stage in the process of consideration. Each sales contract passes through various stages until reaching a winning stage, if not rejected at some previous stage. At a given time, a sales contract can be in one or more of the available stages, which can include, for example, identification, validation, qualification, conditional, and winning.

A sales contract may be in the identification stage when the vendor identifies an organization for which the sales contract can be made. The sales contract may be in the validation stage after the vendor has validated that the organization is a reasonable target for sales. The sales contract may be in the qualification stage after contact is made with the organization, and it has been confirmed that the organization is a target for sales. The sales contract may be in the conditional stage when an initial sales contract has been drafted for the organization, and the sales contract may be in the winning stage after the organization has agreed to purchase goods or services under the sales contract.

At the acceptance, or winning, stage of a sales contract, the vendor receives or accrues the value of that contract. In other words, each contract eventually has a value of zero or the value of its price, where the value of zero occurs if the contract is not accepted by the customer, and the value is its price if it is accepted by the customer. The actual pipeline value at a given time is the value of the contracts in the pipeline that will eventually be accepted by the end of the business period. Thus, the actual pipeline value of a pipeline is not known until the end of the business period.

Estimating pipeline value, also referred to as predicting the pipeline value, is important because the pipeline value can play a role in revenue predictions, which can play a role in making choices related to running a business. Conventional methods of pipeline estimation make predictions based on past pipeline values for previous periods, which can be represented by time series data. A curve can be fit to historical pipeline values, and that curve can be used to predict pipeline values.

### SUMMARY

According to an embodiment of this disclosure, a computer-implemented method includes learning one or more historical curves based on historical data that describes two or more historical pipelines of sales contracts. Each of the one or more historical curves is based on a corresponding historical pipeline of the two or more historical pipelines. Two or more similarity indices are generated, where each similarity index corresponds to a historical pipeline of the two or more historical pipelines, and each similarity index is based on similarity between the corresponding historical pipeline and a target pipeline for which a prediction is sought. A first curve is fit, by a computer processor, to the target pipeline, where the target pipeline has unknown data, and the first curve is based on the two or more similarity indices. A pipeline value of the target pipeline is predicted based on the first curve.

In another embodiment, a system includes a memory having computer readable instructions and one or more processors for executing the computer readable instructions. The computer readable instructions include learning one or more historical curves based on historical data that describes two or more historical pipelines of sales contracts. Each of the one or more historical curves is based on a corresponding historical pipeline of the two or more historical pipelines. Further according to the computer readable instructions, two or more similarity indices are generated. Each similarity index corresponds to a historical pipeline of the two or more historical pipelines, and each similarity index is based on similarity between the corresponding historical pipeline and a target pipeline for which a prediction is sought. A first curve is fit to the target pipeline, where the target pipeline has unknown data, and the first curve is based on the two or more similarity indices. A pipeline value of the target pipeline is predicted based on the first curve.

In yet another embodiment, a computer program product for predicting a pipeline value includes a computer readable storage medium having program instructions embodied therewith. The program instructions are executable by a processor to cause the processor to perform a method. The method includes learning one or more historical curves based on historical data that describes two or more historical pipelines of sales contracts. Each of the one or more historical curves is based on a corresponding historical pipeline of the two or more historical pipelines. Further according to the method, two or more similarity indices are generated. Each similarity index corresponds to a historical pipeline of the two or more historical pipelines, and each similarity index is based on similarity between the corresponding historical pipeline and a target pipeline for which a prediction is sought. A first curve is fit to the target pipeline, where the target pipeline has unknown data, and the first curve is based on the two or more similarity indices. A pipeline value of the target pipeline is predicted based on the first curve.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a block diagram of a prediction system, according to some embodiments of this disclosure;

FIG. 2 is a flow diagram of a method for predicting a pipeline value, according to some embodiments of this disclosure;

FIG. 3 is a flow diagram of another method for predicting a pipeline value, according to some embodiments of this disclosure;

FIG. 4 is a flow diagram of yet another method for predicting a pipeline value, according to some embodiments of this disclosure; and

FIG. 5 is a block diagram of a computer system for implementing some or all aspects of the prediction system, according to some embodiments of this disclosure.

### DETAILED DESCRIPTION

A pipeline value curve represents changing pipeline value over time. Conventionally, to predict pipeline value, curve-fitting is used to draw a pipeline value curve representing historical pipeline values, with time on the horizontal axis and pipeline value on the vertical axis. Conventionally, a curve is determined based on actual, historical pipeline values, and that curve is then used to predict current or future pipeline values.

However, in contrast to most time series data, pipeline values are not continuous over history. Realistically, a distinct pipeline value curve could be fit for each business period. Additionally, the nature of business makes old data (e.g., more than two years old) irrelevant to predicting the near future. As a result, common models for time-series analysis cannot accurately predict pipeline value.

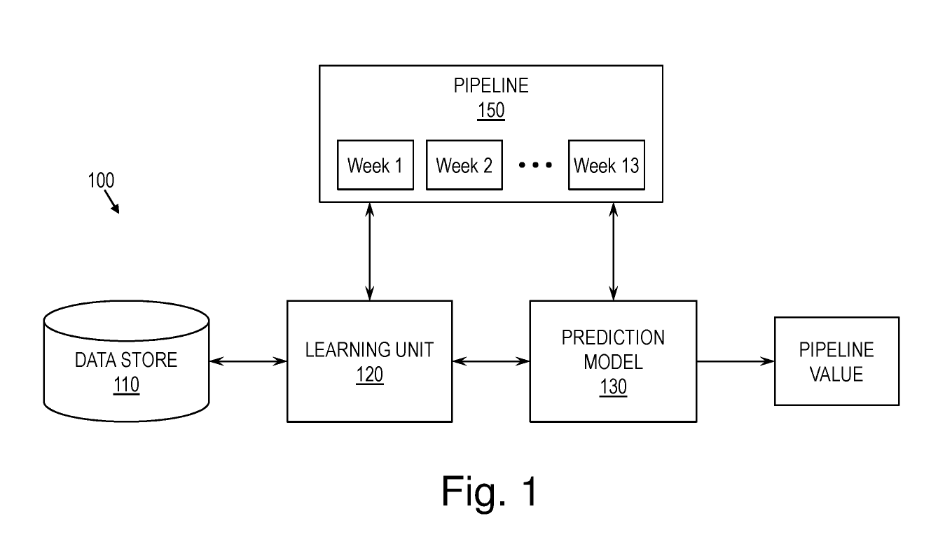

FIG. 1 is a block diagram of a prediction system 100, according to some embodiments of this disclosure. The prediction system 100 may be configured to predict a value of a target pipeline 150, which may be a current pipeline 150 or a future pipeline 150.

As shown, the prediction system 100 may include a data store 110, such as a database or other form of data storage, a learning unit 120, and a prediction model 130. The data store 110 may store historical data describing historical pipelines 150 and their values. The learning unit 120 may learn from that historical data, thus generating the prediction model 130. The prediction model 130 may take a description of a target pipeline 150 and may generate a predicted, or estimated, value of the target pipeline 150.

In some embodiments, each pipeline 150, whether historical, current, or future, may span a fixed business period, such as a quarter. Each period may be further divided into a series of sub-periods, such as weeks within a quarter, as in the example of FIG. 1. Specifically, FIG. 1 illustrates a target pipeline 150 having thirteen weeks within a quarter. At a given time within an ongoing period, zero or more of the sub-periods may have occurred already, and data describing those sub-periods may thus be known. However, one or more later sub-periods may not have yet occurred, and thus data describing those later sub-periods may not be known.

The historical data stored in the data store 110 may include data about historical pipelines 150, also referred to as past pipelines 150, each of which may correspond to a historical period. In some embodiments, each historical, current, or future pipeline 150 may represent a segment of a single, long-term pipeline spanning multiple periods. In other words, the various historical pipelines 150 may be previous states of a long-term pipeline of which a target pipeline 150 for which a prediction is sought is also a part, and each historical pipeline 150 may represent a distinct past period of that long-term pipeline.

For each historical pipeline 150, the historical data may include the actual, intermediate pipeline value at various points in time within the corresponding period of the historical pipeline 150. For instance, in the historical data, each historical pipeline 150 may be represented by an X=[x₁, x₂, . . . x_{N}], where each xᵢ represents an intermediate pipeline value occurring within the period of the historical pipeline. There may be N sub-periods in the period, where each xᵢ is the pipeline value at a point in a corresponding i^{th} sub-period (e.g., at the end of the sub-period). Thus, for each historical pipeline 150, x_{N} may represent the historical pipeline value at the end of the period and, further, the pipeline value of the period as a whole. For instance, the k^{th} historical pipeline may be represented by Xₖ=[x_{k,1}, X_{k,2}, . . . x_{k,N}], where x_{k,N} may be the value of the k^{th} historical pipeline as a whole.

Each pipeline 150 may have a corresponding context, which may be a business context existing during the period corresponding to that pipeline 150. The context of each historical pipeline 150 may be represented in the historical data. For example, and not by way of limitation, the context of a pipeline 150 may be represented by a context feature vector, with each element of the context feature vector representing a predefined aspects of the business. For instance, a first element of the context feature vector representing a pipeline's context may represent the stock price of the organization during the corresponding period, while another element may represent a count of social media mentions during those periods.

In some embodiments, an element of the context feature vector may identify the current period within frame of a calendar year. For example, and not by way of limitation, if the historical pipeline 150 corresponds to, respectively, the first quarter, second quarter, third quarter, or fourth quarter of a year, then the value of this element of the context feature vector may be, respectively, 1, 2, 3, or 4. Thus, the context feature vector for a historical pipeline 150 may provide information about the state of the business during the period of that historical pipeline 150.

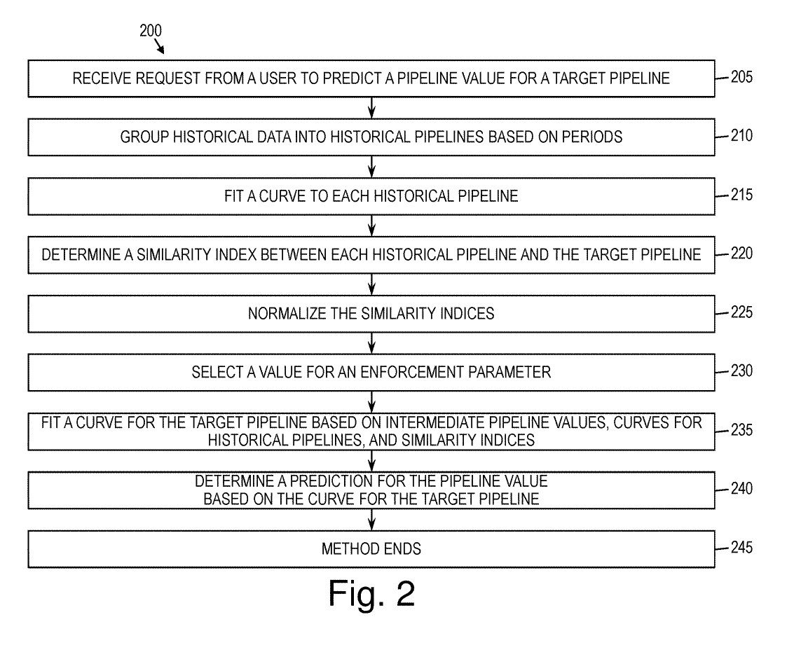

FIG. 2 is a flow diagram of a method 200 for predicting a pipeline value, according to some embodiments of this disclosure. At block 205, the prediction system 100 may receive a request from a user to predict a pipeline value of a target pipeline 150. In some embodiments, this request may initiate further operations of the method 200.

As discussed above, the historical data may be organized into historical pipelines 150, each spanning a period's worth of time. However, in some embodiments, the historical data need not already be arranged into individual historical pipelines 150, upon initiation of this method 200. Rather, the historical data may include data about intermediate pipeline values and about context, without separation based on periods. In that case, at block 210, the prediction system 100 may group the historical data into historical pipelines 150 based on periods, where each historical pipeline 150 spans and corresponds to a period.

As shown, at block 215, the prediction system 100 may fit a curve to each historical pipeline 150 in the historical data. This may be performed by the learning unit 120 shown in FIG. 1, and these curves may later be used to predict pipeline values for the target pipeline 150. Some embodiments of the prediction system 100 may use a multinomial curve for each historical pipeline 150. For a multinomial curve of order n, the fitted curve may be defined by n parameters W=[w₁, w₂, . . . wₙ]. Thus, for the k^{th} historical pipeline 150, the fitted curve may be defined by Wₖ=[w_{k,1}, w_{k,2}, . . . w_{k,n}].

Specifically, for the k^{th} historical pipeline 150 in the historical data, the predication system 100 may compute Wₖ by minimizing, or seeking to minimize, the following objective function L:

$$L ( {W}_{k} , {X}_{k} ) = {\sum }_{i = 1}^{N} ( {x}_{k , i} - {\sum }_{j = 0}^{n} {w}_{k , j} \cdot {t}^{j} ) + γ {\sum }_{j = 0}^{n} {w}_{k , j}^{2}$$

Various mathematical tools existing in the art may be used to compute the value of Wₖ given the above formula. In the above, γ is a predefined parameter to avoid overfitting, which may range from 0 to 1 for example.

A benefit of some embodiments of the prediction system 100 over conventional systems is the ability to consider a context (i.e., business climate) of the target pipeline 150, as compared to contexts of historical pipelines 150. For instance, if the context of the target pipeline 150 is similar to that of a particular historical pipeline 150, then that historical pipeline 150 may receive heavier consideration than others in predicting the pipeline value. Further, as mentioned above, a context feature vector may include an indication of each pipeline's period within a frame of the calendar year. Thus, a similarity in period between the target pipeline 150 and a particular historical pipeline 150 (e.g., both occurring during the third quarter of a year) may play a role in predicting pipeline value. To this end, in some embodiments, the prediction system 100 may be configured to compute similarity indices between pairs of pipelines 150. Conventional methods do not differentiate historical data based on context in training or in prediction.

At block 220, for each historical pipeline 150 described in the historical data, the prediction system 100 may determine a similarity index between that historical pipeline 150 and the target pipeline 150 for which a prediction is sought. As discussed above, each pipeline 150 may be associated with a context feature vector, describing the context of that pipeline 150. Where c is the context feature vector of the target pipeline 150, and where cₖ represents the context feature vector of the k^{th} historical pipeline 150, the contextual similarity index simₖ between these two pipelines may be computed as the cosine similarity, as follows:

$${sim}_{k} = \frac{c \cdot {c}_{k}}{\vert c \vert \cdot \vert {c}_{k} \vert}$$

At block 225, given the computed similarity indices for the various historical pipelines 150, the prediction system 100, may normalize these similarity indices. This may result in a normalized similarity index for each historical pipeline 150, as compared to the pipeline for which a prediction is sought. In some embodiments, the following formula may be used to compute a normalized similarity index s̅i̅m̅ₖ̅ for the k^{th} historical pipeline 150, given a total of n historical pipelines 150:

$$\overline{{sim}_{k}} = \frac{{sim}_{k}}{{Σ}_{j = 1}^{n} {sim}_{j}}$$

In some embodiments, the computation of similarity indices and normalized similarity indices may be performed by the learning unit 120. Together, the value of W=[w₁, w₂, . . . wₙ] for each historical pipeline 150 and the computed similarity indices may form the prediction model 130, by which the value of the target pipeline 150 may be predicted.

To perform the prediction, the prediction system 100 may determine how heavily to weight the context of the target pipeline 150 (i.e., how heavily to weight comparisons between the context and the contexts of historical pipelines 150). An enforcement parameter λ may be indicative of the weight given to context, with a higher value of λ leading to a greater weight. Thus, at block 230, the prediction system 100 may select a value for the enforcement parameter λ, which may be between 0 and 1.

As with historical pipelines 150, the target pipeline 150, which may be a current or future pipeline 150, may be represented by an X=[x₁, x₂, . . . x_{N}]. However, because the target pipeline 150 presumably has unknown data (i.e., one or more intermediate pipeline values are unknown), that target pipeline 150 may be represented by X*, which has unknown values for one or more of its intermediate pipeline values.

At block 235, the prediction system 100 may fit a curve for the target pipeline 150, based on the known values of X*, the curves fit to the historical pipelines 150, and the various similarity indices. The fitted curve may be defined by a W*=[w_{*,1}, w_{*,2}, . . . w_{*,n}]. Specifically, in some embodiments, the prediction system 100 may compute W* by seeking to minimize the following objective function:

$${L}_{2} ( {W}^{*} , {X}^{*} ) = ( 1 - λ ) L ( {W}^{*} , {X}^{*} ) + λ {\sum }_{i = 1}^{n} \overline{{sim}_{i}} \cdot {‖ {W}^{*} - {W}_{i} ‖}^{2}$$

The above function incorporates a least-squares error between parameters of the curve being fit to the target pipeline 150 and the curves fit to the historical pipelines 150, in the form of ∥W*−Wᵢ∥². It will be understood by one skilled in the art that some other objective function may be selected in place of the one shown above, and the selected objective function may likewise incorporate such a least-squares error, which may be weighted based on the enforcement parameter, the similarity indices, or a combination of both.

Another benefit of the prediction system 100 is that, in some embodiments, as demonstrated above, the prediction system 100 may consider partial data existing for the target pipeline 150. In contrast, conventional systems for predicting pipeline value make predictions entirely based on historical pipeline values for periods that are complete. These conventional systems thus ignore important data available to them.

At block 240, the prediction system 100 may determine a prediction for the value of the target pipeline 150. For instance, this may be performed by selecting, on the fitted curve of the target pipeline 150, the pipeline value corresponding to the time at the close of the period. At block 245, the method 200 may end with the pipeline value having been predicted.

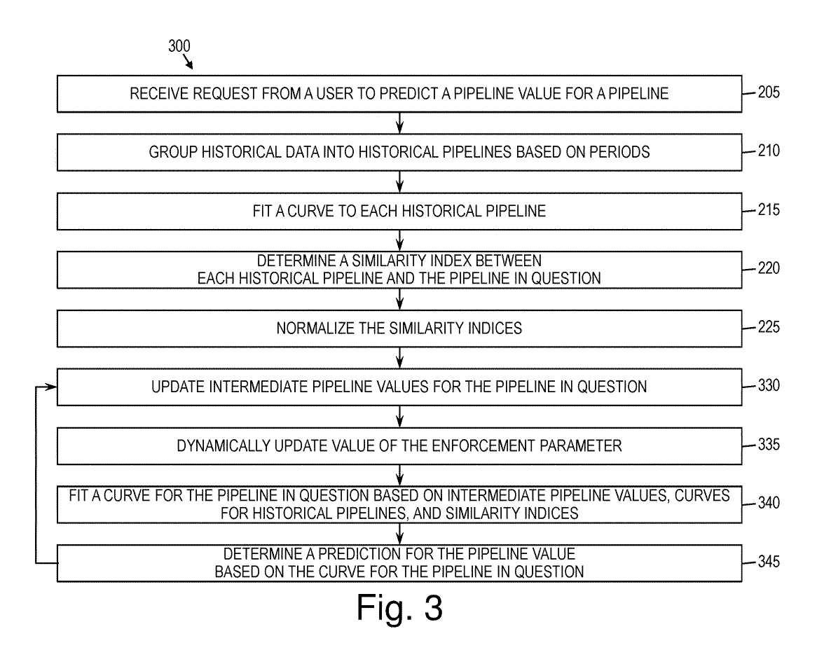

FIG. 3 is a flow diagram of another method 300 for predicting a pipeline value, according to some embodiments of this disclosure. As shown, the method 300 of FIG. 3 is similar to the method of FIG. 2. Specifically, blocks 205-225 are the same in both methods. The method 300 of FIG. 3, however, demonstrates that one may wish to predict the pipeline value more than once. As time passes, X*, the known data about the target pipeline 150, may be updated. As a result, the predicted pipeline value may change and may be more accurate than at previous times, given more data on which to base the prediction.

At block 330, the value of X* may be updated to reflect the addition of new data about the current pipeline.

At block 335, the prediction system 100 may dynamically update the value of the enforcement parameter λ. This updating may occur, for example, periodically or before each instance of predicting the pipeline value. Thus, the value of the enforcement parameter may change over time and may therefore differ from one calculation of the pipeline value to the next. In determining the enforcement parameter, the prediction system 100 may consider one or both of (1) the number of available intermediate pipeline values, m, in the target pipeline 150 and (2) the sharpness of the curve that is being fit.

Specifically, for example, the enforcement parameter may be updated from time to time (e.g., periodically) as follows:

$$λ ( {X}^{*} ) = \{ \begin{matrix}if m = 0 , & 1 \\ otherwise , & \frac{2}{1 + e \frac{\vert {X}^{*} ( m ) - {X}^{*} ( m - 1 ) \vert}{m}} - 1\end{matrix}$$

In the above, λ(X*) represents the value of the enforcement parameter λ as a function of X*; m is the number of known pipeline values x_{*,i} in X*; and X*(m) and X*(m−1) are respectively the values of X*, respectively, with m intermediate pipeline values and with m−1 intermediate pipeline values.

At block 340, as at block 235, a fitted curve is determined for the target pipeline 150 defined by X*, where the fitted curve is defined by W*. At block 345, the prediction system 100 may determine a prediction for the value of the target pipeline 150, such as by selecting, on the fitted curve, the pipeline value corresponding to the time at the close of the period.

The method 300 may then return to block 330 to once again update the value of X*. Blocks 330 through 345 may be repeated each time a user or administrator wishes to compute a new predicted pipeline value for the pipeline represented by X*.

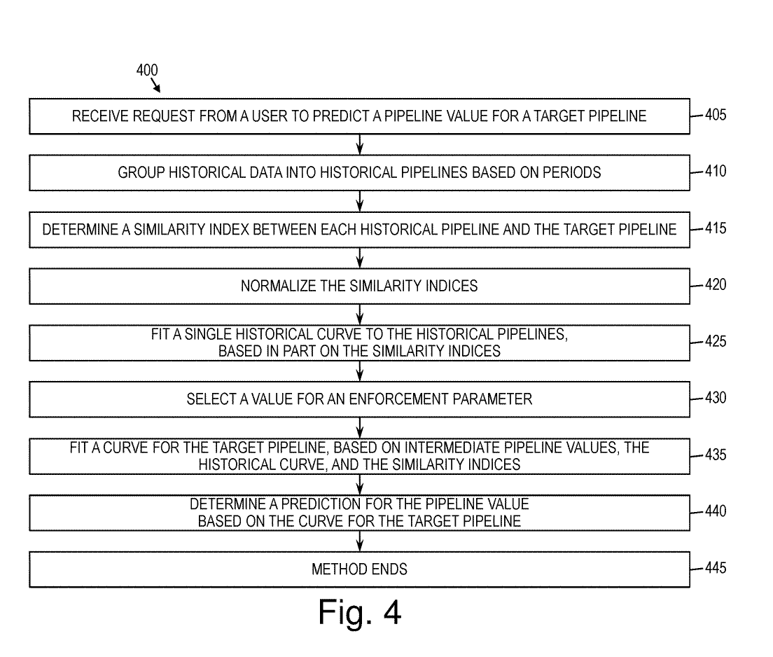

FIG. 4 is a flow diagram of yet another method 400 for predicting a pipeline value, according to some embodiments of this disclosure. Specifically, FIG. 4 illustrates a method 400 in which a single curve is fit across the various historical pipelines 150, but the context of those historical pipelines 150 is still considered. This method 400 may have similarities to the method 200 of FIG. 4, with the changes described below.

At block 405, the prediction system 100 may receive a request from a user to predict a pipeline value of a target pipeline 150. If the historical data is not already be arranged into individual historical pipelines 150, then at block 410, the prediction system 100 may group the historical data into historical pipelines 150 based on periods, where each historical pipeline 150 spans and corresponds to a period.

At block 415, for each historical pipeline 150 described in the historical data, the prediction system 100 may determine a similarity index between that historical pipeline 150 and the target pipeline 150 for which a prediction is sought. At block 420, given the computed similarity indices for the various historical pipelines 150, the prediction system 100, may normalize these similarity indices. This may result in a normalized similarity index for each historical pipeline 150, as compared to the pipeline for which a prediction is sought. The similarity indices may be computed and normalized as discussed above with respect to blocks 220 and 225 of FIG. 2.

At block 425, the prediction system 100 may fit a single historical curve across the various historical pipelines 150, based in part on the similarity indices. For instance, the contribution from each historical pipeline 150 to the historical curve may be weighted based on the respective similarity index of that historical pipeline 150. In some embodiments, the historical curve may be a multinomial curve defined by n parameters W₀=[w_{0,1}, w_{0,1}, . . . w_{0,n}]. Further, in some embodiments, the historical curve may be computed as follows:

$${W}_{0} = {argmin}_{W} ( {\sum }_{i = 1}^{n} \overline{{sim}_{i}} \cdot L ( W , {X}_{i} ) )$$

In some embodiments, computation of this historical curve may be performed by the learning unit 120, and the resulting value of W₀ for the combined historical pipelines 150 may form the prediction model 130, by which the value of the target pipeline 150 may be predicted.

At block 430, the prediction system 100 may select a value for the enforcement parameter k, which may be between 0 and 1. As illustrated by FIG. 3, this enforcement parameter may be updated dynamically.

The target pipeline 150 may be represented by an X=[x₁, x₂, . . . x_{N}]. However, because the target pipeline 150 presumably has unknown data, that target pipeline 150 may be represented by X*, which has unknown values for one or more of its intermediate pipeline values.

At block 435, the prediction system 100 may fit a curve for the target pipeline 150, based on the known values of X*, the historical curve fit to the historical pipelines 150, and the similarity indices. The fitted curve for the target pipeline 150 may be defined by a W*=[w_{*,1}, w_{*,2}, . . . w_{*,n}]. Specifically, in some embodiments, the prediction system 100 may compute W* by seeking to minimize the following objective function, where L( ) refers to the objective function described above with respect to block 215 of FIG. 2:

L₂(W*,X*)=(1−λ)L(W*,X*)+λ∥W*−W₀∥²

Although the similarity indices do not appear in the above function, the resulting curve may still be based on the similarity indices, as those similarity indices may be represented in the historical curve W₀.

As with the objective function of block 235 in FIG. 2, a least-squares error is incorporated, in this case between parameters of the curve being fit to the target pipeline 150 and the historical fit to the historical pipelines 150, in the form of ∥W*−W₀∥². It will be understood by one skilled in the art that some other objective function may be selected in place of the one shown above, and the selected objective function may likewise incorporate such a least-squares error, which may be weighted based on the enforcement parameter, the similarity indices, or a combination of both.

At block 440, the prediction system 100 may determine a prediction for the value of the target pipeline 150. For instance, this may be performed by selecting, on the fitted curve of the target pipeline 150, the pipeline value corresponding to the time at the close of the period. At block 445, the method 400 may end with the pipeline value having been predicted.

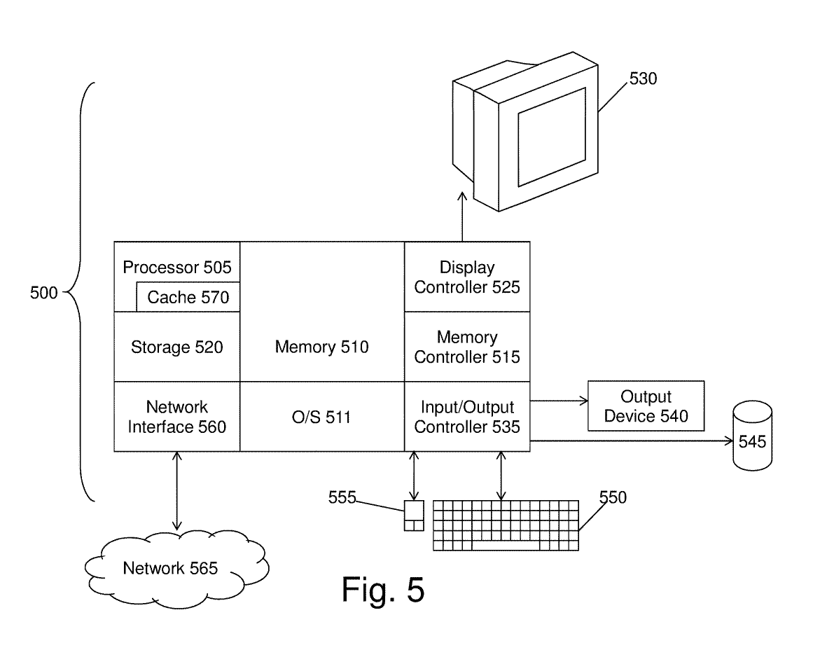

FIG. 5 illustrates a block diagram of a computer system 500 for use in implementing a prediction system 100 or method according to some embodiments. The prediction systems 100 and methods described herein may be implemented in hardware, software (e.g., firmware), or a combination thereof. In some embodiments, the methods described may be implemented, at least in part, in hardware and may be part of the microprocessor of a special or general-purpose computer system 500, such as a personal computer, workstation, minicomputer, or mainframe computer.

In some embodiments, as shown in FIG. 5, the computer system 500 includes a processor 505, memory 510 coupled to a memory controller 515, and one or more input devices 545 and/or output devices 540, such as peripherals, that are communicatively coupled via a local I/O controller 535. These devices 540 and 545 may include, for example, a printer, a scanner, a microphone, and the like. Input devices such as a conventional keyboard 550 and mouse 555 may be coupled to the I/O controller 535. The I/O controller 535 may be, for example, one or more buses or other wired or wireless connections, as are known in the art. The I/O controller 535 may have additional elements, which are omitted for simplicity, such as controllers, buffers (caches), drivers, repeaters, and receivers, to enable communications.

The I/O devices 540, 545 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 505 is a hardware device for executing hardware instructions or software, particularly those stored in memory 510. The processor 505 may be a custom made or commercially available processor, a central processing unit (CPU), an auxiliary processor among several processors associated with the computer system 500, a semiconductor based microprocessor (in the form of a microchip or chip set), a macroprocessor, or other device for executing instructions. The processor 505 includes a cache 570, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 570 may be organized as a hierarchy of more cache levels (L1, L2, etc.).

The memory 510 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 510 may incorporate electronic, magnetic, optical, or other types of storage media. Note that the memory 510 may have a distributed architecture, where various components are situated remote from one another but may be accessed by the processor 505.

The instructions in memory 510 may include one or more separate programs, each of which comprises an ordered listing of executable instructions for implementing logical functions. In the example of FIG. 5, the instructions in the memory 510 include a suitable operating system (OS) 511. The operating system 511 essentially may control the execution of other computer programs and provides scheduling, input-output control, file and data management, memory management, and communication control and related services.

Additional data, including, for example, instructions for the processor 505 or other retrievable information, may be stored in storage 520, which may be a storage device such as a hard disk drive or solid state drive. The stored instructions in memory 510 or in storage 520 may include those enabling the processor to execute one or more aspects of the prediction systems 100 and methods of this disclosure.

The computer system 500 may further include a display controller 525 coupled to a display 530. In some embodiments, the computer system 500 may further include a network interface 560 for coupling to a network 565. The network 565 may be an IP-based network for communication between the computer system 500 and an external server, client and the like via a broadband connection. The network 565 transmits and receives data between the computer system 500 and external systems. In some embodiments, the network 565 may be a managed IP network administered by a service provider. The network 565 may be implemented in a wireless fashion, e.g., using wireless protocols and technologies, such as WiFi, WiMax, etc. The network 565 may also be a packet-switched network such as a local area network, wide area network, metropolitan area network, the Internet, or other similar type of network environment. The network 565 may be a fixed wireless network, a wireless local area network (LAN), a wireless wide area network (WAN) a personal area network (PAN), a virtual private network (VPN), intranet or other suitable network system and may include equipment for receiving and transmitting signals.

Prediction systems 100 and methods according to this disclosure may be embodied, in whole or in part, in computer program products or in computer systems 500, such as that illustrated in FIG. 5.

Technical effects and benefits of some embodiments include the ability to predict a pipeline's value based on curve-fitting that considers a business context of the pipeline. As a result, the value predicted may more accurately reflect the eventual value of the pipeline.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
learning one or more historical curves based on historical data that describes two or more historical pipelines of sales contracts, each of the one or more historical curves based on a corresponding historical pipeline of the two or more historical pipelines;
generating two or more similarity indices, each similarity index corresponding to a historical pipeline of the two or more historical pipelines, and each similarity index based on similarity between the corresponding historical pipeline and a target pipeline for which a prediction is sought;
fitting, by a computer processor, a first curve to the target pipeline, the target pipeline having unknown data, and the first curve based on the two or more similarity indices; and
predicting a pipeline value of the target pipeline based on the first curve.

2. The computer-implemented method of claim 1, wherein the learning the one or more historical curves comprises learning one curve for each of the two or more historical pipelines.

3. The computer-implemented method of claim 1, wherein the learning one or more historical curves comprises learning a single curve for the two or more historical pipelines combined, based on the two or more similarity indices.

4. The computer-implemented method of claim 1, wherein the fitting the first curve to the target pipeline is further based on one or more intermediate pipeline values in the target pipeline, the one or more intermediate pipeline values comprising values corresponding to one or more intermediate points within a time period of the target pipeline.

5. The computer-implemented method of claim 1, wherein the generating two or more similarity indices comprises:
representing a context of the target pipeline as a first context feature vector;
representing a context of a first historical pipeline, of the two or more historical pipelines, as a historical context feature vector; and
calculating a cosine similarity between the first context feature vector and the historical context feature vector.

6. The computer-implemented method of claim 1, wherein the fitting the first curve to the target pipeline comprises calculating a least-squares error between the first curve and the one or more historical curves.

7. The computer-implemented method of claim 1, wherein the fitting the first curve to the target pipeline comprises:
weighting a contribution of the two or more similarity indices to the first curve, based on an enforcement parameter; and
dynamically updating the enforcement parameter based on data available to describe the target pipeline.

8. A system comprising:
a memory having computer readable instructions; and
one or more processors for executing the computer readable instructions, the computer readable instructions comprising:
learning one or more historical curves based on historical data that describes two or more historical pipelines of sales contracts, each of the one or more historical curves based on a corresponding historical pipeline of the two or more historical pipelines;
generating two or more similarity indices, each similarity index corresponding to a historical pipeline of the two or more historical pipelines, and each similarity index based on similarity between the corresponding historical pipeline and a target pipeline for which a prediction is sought;
fitting a first curve to the target pipeline, the target pipeline having unknown data, and the first curve based on the two or more similarity indices; and
predicting a pipeline value of the target pipeline based on the first curve.

9. The system of claim 8, wherein the learning the one or more historical curves comprises learning one curve for each of the two or more historical pipelines.

10. The system of claim 8, wherein the learning one or more historical curves comprises learning a single curve for the two or more historical pipelines combined, based on the two or more similarity indices.

11. The system of claim 8, wherein the fitting the first curve to the target pipeline is further based on one or more intermediate pipeline values in the target pipeline, the one or more intermediate pipeline values comprising values corresponding to one or more intermediate points within a time period of the target pipeline.

12. The system of claim 8, wherein the generating two or more similarity indices comprises:
representing a context of the target pipeline as a first context feature vector;
representing a context of a first historical pipeline, of the two or more historical pipelines, as a historical context feature vector; and
calculating a cosine similarity between the first context feature vector and the historical context feature vector.

13. The system of claim 8, wherein the fitting the first curve to the target pipeline comprises calculating a least-squares error between the first curve and the one or more historical curves.

14. The system of claim 8, wherein the fitting the first curve to the target pipeline comprises:
weighting a contribution of the two or more similarity indices to the first curve, based on an enforcement parameter; and
dynamically updating the enforcement parameter based on data available to describe the target pipeline.

15. A computer program product for predicting a pipeline value, the computer program product comprising a computer readable storage medium having program instructions embodied therewith, the program instructions executable by a processor to cause the processor to perform a method comprising:
learning one or more historical curves based on historical data that describes two or more historical pipelines of sales contracts, each of the one or more historical curves based on a corresponding historical pipeline of the two or more historical pipelines;
generating two or more similarity indices, each similarity index corresponding to a historical pipeline of the two or more historical pipelines, and each similarity index based on similarity between the corresponding historical pipeline and a target pipeline for which a prediction is sought;
fitting a first curve to the target pipeline, the target pipeline having unknown data, and the first curve based on the two or more similarity indices; and
predicting a pipeline value of the target pipeline based on the first curve.

16. The computer program product of claim 15, wherein the learning the one or more historical curves comprises learning one curve for each of the two or more historical pipelines.

17. The computer program product of claim 15, wherein the learning one or more historical curves comprises learning a single curve for the two or more historical pipelines combined, based on the two or more similarity indices.

18. The computer program product of claim 15, wherein the fitting the first curve to the target pipeline is further based on one or more intermediate pipeline values in the target pipeline, the one or more intermediate pipeline values comprising values corresponding to one or more intermediate points within a time period of the target pipeline.

19. The computer program product of claim 15, wherein the generating two or more similarity indices comprises:
representing a context of the target pipeline as a first context feature vector;
representing a context of a first historical pipeline, of the two or more historical pipelines, as a historical context feature vector; and
calculating a cosine similarity between the first context feature vector and the historical context feature vector.

20. The computer program product of claim 15, wherein the fitting the first curve to the target pipeline comprises calculating a least-squares error between the first curve and the one or more historical curves.
